(19) United States
(12) Patent Application Publication
(10) Pub. No.: US 2014/0185171 A1
(43) Pub. Date: Jul. 3, 2014

(54) THREE-PHASE POWER CONTROL APPARATUS AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: WEN-KAO FENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,668

(22) Filed: Oct. 22, 2013

(30) Foreign Application Priority Data
Dec. 29, 2012 (CN) 2012105893649

(51) Int. Cl. H02H 3/26

(52) U.S. Cl. CPC H02H 3/265
USPC 361/85

(57) ABSTRACT

A three-phase power control apparatus includes a first circuit breaker, a power supply controller, and a three-phase power monitor. When the three-phase power monitor detects an error in three phase voltages provided by a three-phase power supply, the three-phase power monitor transmits a voltage signal to the power supply controller. When the power supply controller receives the voltage signal from the three-phase power monitor, the power supply controller controls the first circuit breaker to disconnect a load from the three-phase power supply. A three-phase power control method is also provided.

### REFERENCE TO RELATED APPLICATIONS

This application claims all benefits accruing under 35 U.S.C. §119 from China Patent Application No. 201210589364.9, filed on Dec. 29, 2012 in the State Intellectual Property Office of China. The contents of the China Application are hereby incorporated by reference.

### BACKGROUND

1. Technical Field

The disclosure generally relates to power control apparatuses and methods, and particularly relates to three-phase AC power control apparatuses and methods.

2. Description of Related Art

A three-phase power system is often used to power large motors and other heavy loads. The three-phase power system is more economical than a single-phase or a two-phase power system at an equivalent voltage level because the three-phase power system uses less conductor material to transmit electrical power. However, some problems, such as a phase sequence error and a phase loss, often occur in the three-phase power system. Such problems may lead to a failure of the equipment and may cause irreversible damages.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a three-phase power control apparatus.

FIG. 2 is a circuit diagram of the three-phase power control apparatus of FIG. 1.

FIG. 3 is a flowchart of one embodiment of a three-phase power control method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

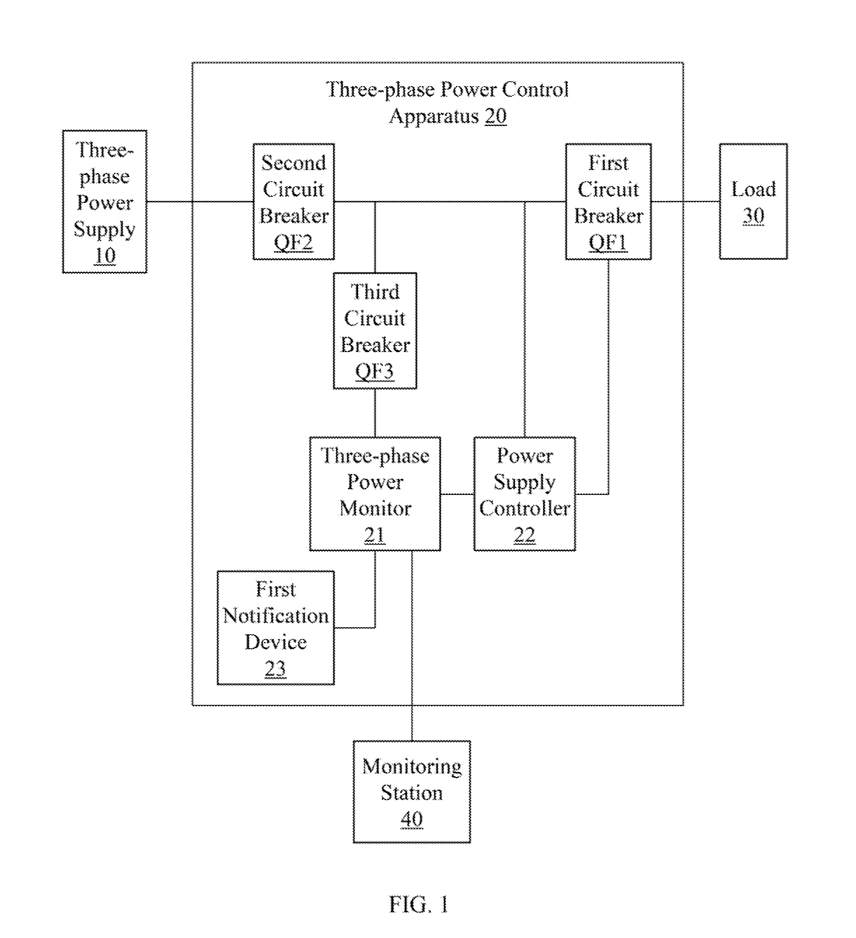

FIG. 1 shows one embodiment of a three-phase power control apparatus 20. The three-phase power control apparatus 20 includes a first circuit breaker QF1, a second circuit breaker QF2, a second circuit breaker QF3, a three-phrase power monitor 21, a power supply controller 22, and a first notification device 23.

An input terminal of the three-phase power control apparatus 20 is connected to a three-phase power supply 10. An output terminal of the three-phase power control apparatus is connected to a load 30. The load 30 may be a motor, an industrial air conditioner or other electronic device.

An input terminal of the first circuit breaker QF1 is connected to an output terminal of the second circuit breaker QF2. An input terminal of the second circuit breaker QF2 is connected to the three-phase power supply 10. An output terminal of the first circuit breaker QF1 is connected to the load 30.

An input terminal of the third circuit breaker QF3 is connected to the output terminal of the circuit breaker QF2. An output terminal of the third circuit breaker QF3 is connected to an input terminal of the three-phase power monitor 21.

The three-phase power monitor 21 monitors three phase voltages provided by the three-phase power supply 10. An output terminal of the three-phase power monitor 21 is connected to the power supply controller 22 and the first notification device 23. When the three-phase power monitor 21 detects an error in the three phase voltages provided by the three-phase power supply 10, the three-phase power monitor 21 transmits a voltage signal to the power supply controller 22 and the first notification device 23.

The power supply controller 22 is connected to the output terminal of the second circuit breaker QF2 and may receive one of three phase voltages from the three-phase power supply 10. The power supply controller 22 is connected to a control terminal of the first circuit breaker QF1. When the power supply controller 22 receives a voltage signal from the three-phase power monitor 21, the power supply controller 22 controls the first circuit breaker QF1 to disconnect the load 30 from the three-phase power supply 10.

When the first notification device 23 receives a voltage signal from the three-phase power monitor 21, the first notification device 23 makes a public announcement to inform the proximate persons of the need to take action, for example, to cut off the three-phase power supply 10. In one embodiment, the first notification device 23 may include a strobe light which flashes light when the first notification device 23 receives the voltage signal from the three-phase power monitor 21. In some other embodiments, the first notification device 23 may include a speaker which sounds alarms when the first notification device 23 receives the voltage signal from the three-phase power monitor 21.

In some embodiments, when the first notification device 23 receives a voltage signal from the three-phase power monitor 21, the first notification device 23 transmits an alarm signal to a remotely located monitoring station 20 via an Internet Protocol (IP) network. The monitoring station 20 may provide a visible or audible interface to inform the related persons.

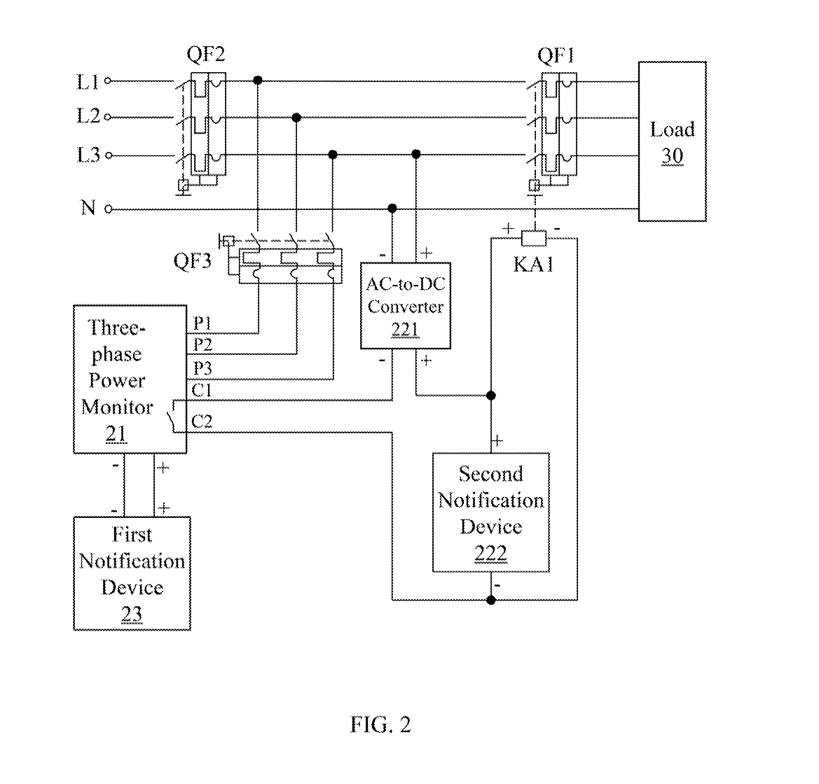

FIG. 2 shows a circuit diagram of the three-phase power control apparatus 20. The load 30 is connected to three phase power lines L1, L2, and L3 of the three-phase power supply 10 through the first circuit breaker QF1 and the second circuit breaker QF2.

Input pins P1, P2, P3 of the three-phase power monitor 21 are respectively connected to the phase power lines L1, L2, and L3 of the three-phase power supply 10 through the third circuit breaker QF3 and the second circuit breaker QF2.

The power supply controller 22 includes an AC-to-DC converter 221 and a second notification device 222. The input terminal of the AC-to-DC converter 221 is connected to one of the phase power lines L1, L2, and L3 of the three-phase power supply 10. For example, the input terminal of the AC-to-DC converter 221 is connected to the phase power line L3 of the three-phase power supply 10. The AC-to-DC converter 221 receives a phase AC voltage from the three-phase power supply 10 and converts the phase AC voltage into a DC voltage.

A cathode output terminal of the AC-to-DC converter 221 is connected to a first normally open contact C1 of the three-phase power monitor 21. An anode output terminal of the AC-to-DC converter 221 is connected to an anode input terminal of the second notification device 222. A cathode input terminal of the second notification device 222 is connected to a second normally open contact C2 of the three-phase power monitor 21.

The first normally open contact C1 is disconnected from the second normally open contact C2 under normal circumstances, that means, for most of the time, the AC-to-DC converter 221 does not provide the DC voltage to the second notification device 222.

When the three-phase power monitor 21 detects an error in the three phase voltages provided by the three-phase power supply 10, the three-phase power monitor 21 connects the first normally open contact C1 to the second normally open contact C2. Then the AC-to-DC converter 221 provides the DC voltage to the second notification device 222. The second notification device 222 is powered to make a public announcement to inform the proximate persons of the need to take action, for example, to cut off the three-phase power supply 10. In one embodiment, the second notification device 222 may include a strobe light which flashes light when the second notification device 222 receives the voltage signal from the three-phase power monitor 21. In some other embodiments, the second notification device 222 may include a speaker which sounds alarms when the second notification device 222 receives the voltage signal from the three-phase power monitor 21.

The power supply controller 20 further includes an opening solenoid KA1. An output terminal of the opening solenoid KA1 is connected to the control terminal of the first circuit breaker QF1. An anode input terminal of the opening solenoid KA1 is connected to the anode output terminal of the AC-to-DC converter 221. A cathode input terminal of the opening solenoid KA1 is connected to the second normally opening contact C2 of the three-phase power monitor 21. The opening solenoid KA1 and the second notification device 222 are connected to the AC-to-DC converter 221 in parallel.

When the three-phase power monitor 21 detects an error in the three phase voltages provided by the three-phase power supply 10, the three-phase power monitor 21 connects the first normally open contact C1 to the second normally open contact C2. Then the AC-to-DC converter 221 provides the DC voltage to the opening solenoid KA1. The opening solenoid KA1 outputs a control signal to the first circuit breaker QF1. The first circuit breaker QF1 disconnects the load 30 from the three-phase power supply 10 in response to receiving the control signal from the opening solenoid KA1.

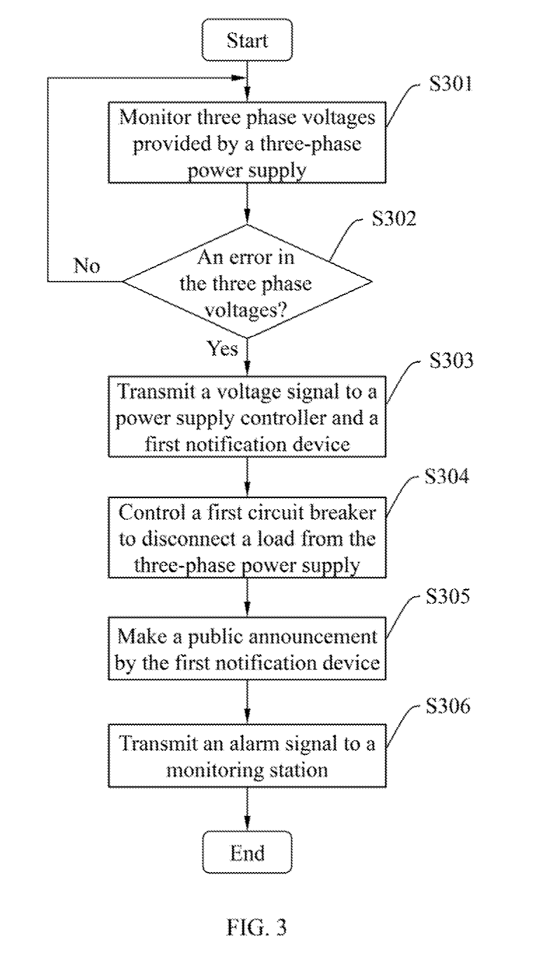

FIG. 3 shows a flowchart of one embodiment of a three-phase power control method. The method includes the following steps.

In step S301, the three-phase power monitor 21 monitors the three phase voltages provided by the three-phase power supply 10.

In step 302, if the three-phase power monitor 21 detects an error in the three phase voltages provided by the three-phase power supply 10, the flow proceeds to step S303. Otherwise, the flow proceeds to step S301.

In step 303, the three-phase power monitor 21 transmits a voltage signal to the power supply controller 22 and the first notification device 23.

In step 304, the power supply controller 22 controls the first circuit breaker QF1 to disconnect the load 30 from the three-phase power supply 10.

In step 305, the first notification device 23 makes a public announcement to inform the proximate persons of the need to take action, for example, to cut off the three-phase power supply 10.

In step 306, when the first notification device 23 receives a voltage signal from the three-phase power monitor 21, the first notification device 23 transmits an alarm signal to the remotely located monitoring station 20 via an IP network.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A three-phase power control apparatus, comprising:
a first circuit breaker, wherein an input terminal of the first circuit breaker is configured to be connected to a three-phase power supply, and an output terminal of the first circuit breaker is configured to be connected to a load;
a power supply controller connected to a control terminal of the first circuit breaker; and
a three-phase power monitor, wherein an input terminal of the three-phase power monitor is connected to the three-phase power supply, an output terminal of the three-phase power monitor is connected to the power supply controller, the three-phase power monitor is configured to monitor three phase voltages provided by the three-phase power supply;
wherein when the three-phase power monitor detects an error in the three phase voltages, the three-phase power monitor is configured to transmit a voltage signal to the power supply controller, when the power supply controller receives the voltage signal from the three-phase power monitor, the power supply controller is configured to control the first circuit breaker to disconnect the load from the three-phase power supply.

2. The three-phase power control apparatus of claim 1, further comprising a first notification device connected to the three-phase power monitor, wherein when the three-phase power monitor detects the error in the three phase voltages, the three-phase power is further configured to transmit a voltage signal to the first notification device, when the first notification device receives the voltage signal from the three-phase power monitor, the first notification device is configured to makes a public announcement.

3. The three-phase power control apparatus of claim 2, wherein the first notification device comprises a strobe light configured to flash light when the first notification device receives the voltage signal from the three-phase power monitor.

4. The three-phase power control apparatus of claim 2, wherein the first notification device comprises a speaker configured to sound alarms when the first notification device receives the voltage signal from the three-phase power monitor.

5. The three-phase power control apparatus of claim 1, wherein the power supply controller comprises an AC-to-DC converter, an input terminal of the AC-to-DC converter is connected to one of three phase power lines of the three-phase power supply, a cathode output terminal of the AC-to-DC converter is connected to a first normally open contact of the three-phase power monitor, the AC-to-DC converter is configured to receive a phase AC voltage from the three-phase power supply and convert the phase AC voltage into a DC voltage.

6. The three-phase power control apparatus of claim 5, wherein the power supply controller further comprises an opening solenoid, an anode input terminal of the opening solenoid is connected to an anode output terminal of the AC-to-DC converter, a cathode input terminal of the opening solenoid is connected to a second normally opening contact of the three-phase power monitor, an output terminal of the opening solenoid is connected to the control terminal of the first circuit breaker.

7. The three-phase power control apparatus of claim 6, wherein when the three-phase power monitor detects the error in the three phase voltages provided by the three-phase power supply, the three-phase power monitor connects the first normally open contact to the second normally open contact, the AC-to-DC converter provides the DC voltage to the opening solenoid, the opening solenoid is configured to output a control signal to the first circuit breaker, and the first circuit breaker is configured to disconnect the load from the three-phase power supply in response to receiving the control signal from the opening solenoid.

8. The three-phase power control apparatus of claim 7, wherein the power supply controller further comprises a second notification device, an anode input terminal of the second notification device is connected to the anode output terminal of the AC-to-DC converter, a cathode input terminal of the second notification device is connected to the second normally open contact of the three-phase power monitor.

9. The three-phase power control apparatus of claim 8, wherein when the three-phase power monitor detects an error in the three phase voltages provided by the three-phase power supply, the three-phase power monitor is configured to connect the first normally open contact to the second normally open contact, the AC-to-DC converter provides the DC voltage to the second notification device, and the second notification device is configured to make a public announcement.

10. The three-phase power control apparatus of claim 9, wherein the second notification device and the opening solenoid are connected to the AC-to-DC converter in parallel.

11. The three-phase power control apparatus of claim 9, wherein the second notification device comprises a strobe light configured to flash light when the AC-to-DC converter provides the DC voltage to the second notification device.

12. The three-phase power control apparatus of claim 9, wherein the second notification device comprises a speaker configured to sound alarms when the AC-to-DC converter provides the DC voltage to the second notification device.

13. The three-phase power control apparatus of claim 1, wherein the three-phase power monitor is further configured to transmit an alarm signal to a remotely located monitoring station via an Internet Protocol (IP) network.

14. A three-phase power control method, comprising:
monitoring, by a three-phase power monitor, three phase voltages provided by a three-phase power supply;
when the three-phase power monitor detects an error in the three phase voltages provided by the three-phase power supply, transmitting a voltage signal to a power supply controller by the three-phase power monitor; and
controlling, by the power supply controller, a first circuit breaker to disconnect a load from the three-phase power supply.

15. The three-phase power control method of claim 14, further comprising:
when the three-phase power monitor detects the error in the three phase voltages provided by the three-phase power supply, transmitting a voltage signal to a first notification device by the three-phase power monitor; and
making a public announcement by the first notification device.

16. The three-phase power control method of claim 15, wherein the making a public announcement comprises sounding alarms.

17. The three-phase power control method of claim 15, wherein the making a public announcement comprises flashing light.

18. The three-phase power control method of claim 14, wherein the power supply controller comprises an AC-to-DC converter, an input terminal of the AC-to-DC converter is connected to one of three phase power lines of the three-phase power supply, a cathode output terminal of the AC-to-DC converter is connected to a first normally open contact of the three-phase power monitor, the method further comprises:
receiving a phase AC voltage from the three-phase power supply by the AC-to DC converter; and
converting the phase AC voltage into a DC voltage by the AC-to-DC converter.

19. The three-phase power control method of claim 18, wherein the power supply controller further comprises an opening solenoid, an anode input terminal of the opening solenoid is connected to an anode output terminal of the AC-to-DC converter, a cathode input terminal of the opening solenoid is connected to a second normally opening contact of the three-phase power monitor, an output terminal of the opening solenoid is connected to the control terminal of the first circuit breaker, the method further comprises:
when the three-phase power monitor detects an error in the three phase voltages provided by the three-phase power supply, connecting the first normally open contact to the second normally open contact by the three-phase power monitor;
providing the DC voltage to the opening solenoid by the AC-to-DC converter;
outputting a control signal to the first circuit breaker by the opening solenoid; and
disconnecting the load from the three-phase power supply by the first circuit breaker in response to receiving the control signal from the opening solenoid.

20. The three-phase power control method of claim 14, further comprising:
when the three-phase power monitor detects the error in the three phase voltages provided by the three-phase power supply, transmitting an alarm signal to a remotely located monitoring station via an IP network.
